(19) United States
(12) Patent Application Publication
(10) Pub. No.: US 2015/0249286 A1
(43) Pub. Date: Sep. 3, 2015

(54) BROADBAND ANTENNA EQUIPPED WITH FERRITE MEMBER

(71) Applicant: Korea Institute of Science and Technology, Seoul (KR)

(72) Inventors: Se-Yun KIM, Seoul (KR); Jae-Hyoung CHO, Seoul (KR); Ji-Hyun JUNG, Seoul (KR)

(73) Assignee: KOREA INSTITUTE OF SCIENCE AND TECHNOLOGY, Seoul (KR)

(21) Appl. No.: 14/498,218

(22) Filed: Sep. 26, 2014

(30) Foreign Application Priority Data
Feb. 28, 2014 (KR) 10-2014-0024586

(51) Int. Cl. H01Q 1/50; H01Q 9/16

(52) U.S. Cl. CPC H01Q 1/50; H01Q 9/16

(57) ABSTRACT

Provided is a broadband antenna including: a coaxial cable; a first arm that is connected to an inner conductor of the coaxial cable and extends in a lengthwise direction of the coaxial cable; a second arm that is formed in a manner that the second arm is connected to an output conductor and surrounds the coaxial cable; and a ferrite member that is formed in such a manner that the ferrite member is adjacent to the second arm and surrounds the coaxial cable to control amounts of current that are distributed along a surface of the outer conductor of the coaxial cable.

### CROSS-REFERENCE TO RELATED APPLICATION

Pursuant to 35 U.S.C. §119(a), this application claims the benefit of earlier filing date and right of priority to Korean Application No. 10-2014-0024586, filed on Feb. 28, 2014, the contents of which is incorporated by reference herein in its entirety.

### BACKGROUND

1. Field

The present invention relates to an antenna to which a radio frequency current is fed using a coaxial cable that is equipped with a ferrite member.

2. Background

In order to feed a radio frequency current to a dipole or monopole antenna using a coaxial cable, a transformer is connected to one end of the coaxial cable, or a matching network is used in such a manner as to match the antenna and the coaxial cable.

If the coaxial cable is connected directly to a feeder without using the transformer or the matching network, mismatch occurs in the feeder. If the antenna is one-half or one-fourth the length of the wavelength it receives, the mismatch have a weak effect on the frequency in this case, but have a strong effect on the other frequencies. The mismatch causes a reflected wave to be formed along an outside of the coaxial cable and changes an electrical length of the antenna, thereby decreasing antenna efficiency and distorting the radiation pattern.

FIGS. 1A and 1B are diagrams illustrating a monopole antenna that is fed using a coaxial cable in the related art.

FIG. 1A illustrates a case where an inner conductor 110 of the coaxial cable is connected to a feeder 201 of an antenna 200. In this case, the antenna has to be designed in such a manner that the coaxial cable having specific impedance is matched to input impedance of the monopole antenna 200. That is, the antenna 200 has to be manufactured in such a manner that its length is equal to one-fourth of the wavelength. To correspond to a large frequency band, a shape of the antenna may be changed as illustrated, but this causes distribution of current in the monopole antenna 200 and distribution of current over an external conductor 120 to be uneven. Thus, a distortion occurs in a radiation pattern, and antenna efficiency is decreased.

FIG. 1B illustrates a case where the inner conductor 110 is connected to the feeder 201 of the monopole antenna and the outer conductor 120 is connected to a conductive surface 130. In this case, the antenna also has to be designed in such a manner that specific impedance of the coaxial cable is matched to input impedance of the monopole antenna 200. That is, the antenna 200 has to be manufactured in such a manner that its length is equal to one-fourth of the wavelength. In addition, a size of the conductive surface 130 is more increased than that of the antenna 200, thereby producing an image antenna effect. That is, a monopole image antenna is formed on the conductive surface in a manner that forms the missing half of the dipole, thereby obtaining the same effect as produced by the dipole antenna. To do this, the conductive surface 130 that is sufficiently large in size is necessary for this case. However, there is a limitation on reducing the size of the antenna.

### SUMMARY

Therefore, an aspect of the detailed description is to provide a new type of coaxial-cable-fed antenna that is capable of removing a guide wave that occurs along a pipe that surrounds an antenna.

Another object of the detailed description is to realize a dipole antenna using an outer conductor of a coaxial cable and to realize a high-performance coaxial-cable-fed antenna that is capable of preventing a radiation pattern from being distorted.

A further object of the detailed description is to provide an antenna that uses a ferrite member to provide performance similar to that accomplished by a resistance load antenna.

To achieve these and other advantages and in accordance with the purpose of this specification, as embodied and broadly described herein, there is provided a broadband antenna including: a coaxial cable; a first arm that is connected to an inner conductor of the coaxial cable and extends in a lengthwise direction of the coaxial cable; a second arm that is formed connected to an output conductor of the coaxial cable, and surrounds the coaxial cable; and a ferrite member that is formed in such a manner that the ferrite member is adjacent to the second arm and surrounds the coaxial cable to control amounts of current that are distributed along a surface of the outer conductor of the coaxial cable.

The broadband antenna may further include a resistance load that is connected to one end of the first arm so as to extend in the lengthwise direction.

The broadband antenna may further include an electric power unit that is connected to the ferrite member.

In the broadband antenna, the electric power unit may include a variable power source.

In the broadband antenna, the electric power unit may include the multiple power sources that are separated from one another in a lengthwise direction of the coaxial cable.

In the broadband antenna, the electric power unit may provide the ferrite member with distribution of current that is matched to distribution of current with which the resistance load is provided. To achieve these and other advantages and in accordance with the purpose of this specification, as embodied and broadly described herein, there is provided a broadband antenna including: a coaxial cable; an antenna arm of the broadband antenna that is connected to an inner conductor of the coaxial cable and extends in a lengthwise direction of the coaxial cable; a balun that connects the coaxial cable and the antenna arm of the broadband antenna; a resistance load that is connected to on one end of the antenna arm of the broadband antenna in such a manner as to extend in a lengthwise direction of the coaxial cable; and a ferrite member that surrounds the coaxial cable to control current that is distributed along an outer conductor of the coaxial cable.

The broadband antenna may further include an electric power unit that is connected to the ferrite member.

In the broadband antenna, the electric power unit may include the multiple power sources that are separated from one another in a lengthwise direction of the coaxial cable.

In the broadband antenna, the electric power unit may provide the ferrite member with distribution of current that is matched to distribution of current with which the arm of the broadband antenna.

To achieve these and other advantages and in accordance with the purpose of this specification, as embodied and broadly described herein, there is provided a broadband dipole antenna including: a coaxial cable; a first arm that is connected to an inner conductor of the coaxial cable; a second arm that is connected to an outer conductor of the coaxial cable and extends; a first ferrite member that is formed in such a manner as to surround the first arm; and a second ferrite member that is formed in such a manner as to surround the second arm.

The broadband dipole antenna may further include electric power units that are connected to the first and second ferrite members in such a manner as to adjust distribution of current with which the first and second arms are formed, respectively.

In the broadband dipole antenna, the electric power units may provide the first arm and the second arm with matched distribution of current, respectively.

In the broadband dipole antenna, each of the electric power units may include multiple power sources that are separated from one another.

In the broadband dipole antenna, each of the electric power units may include a variable power source that changes corresponding to a radio frequency current that is fed to the first and second arms.

Using the coaxial cable, the radio frequency current is fed directly to the broadband antenna with the configuration described above according to at least one embodiment. Thus, a separate matching element is unnecessary.

Therefore, the antenna can be not only made simple in construction, but performance of the antenna can be also improved. In addition, according to the present invention, the use of the coaxial cable can make the broadband antenna simple in construction. Thus, when the broadband antenna is applied to an apparatus that, like an endoscope, is small in width and needs a broad frequency band, performance of the apparatus can be improved.

In addition, in the antenna according to the present invention, a current that is distributed along the coaxial cable can be controlled using the ferrite member, and thus the radiation pattern can be prevented from being distorted due to the coaxial cable.

Furthermore, according to the present invention, an ideal radiation pattern can be formed by connecting the power source to the ferrite member that surrounds the coaxial cable, and an effect that can be obtained by the dipole antenna can be accomplished with the construction of the monopole antenna.

Further scope of applicability of the present application will become more apparent from the detailed description given hereinafter. However, it should be understood that the detailed description and specific examples, while indicating preferred embodiments of the disclosure, are given by way of illustration only, since various changes and modifications within the spirit and scope of the disclosure will become apparent to those skilled in the art from the detailed description.

### BRIEF DESCRIPTION OF THE DRAWINGS

The accompanying drawings, which are included to provide a further understanding of the disclosure and are incorporated in and constitute a part of this specification, illustrate exemplary embodiments and together with the description serve to explain the principles of the disclosure.

In the drawings:

FIGS. 1A and 1B are diagrams illustrating a monopole antenna that is fed using a coaxial cable in the related art;

FIG. 2 is a diagram illustrating a coaxial-cable-fed broadband dipole antenna according to one embodiment of the present invention;

FIGS. 3A to 3D are modification examples of a first arm illustrated in FIG. 2;

FIG. 4 is a cross-sectional diagram illustrating an antenna according to one embodiment of the present invention, taken along a line IV-IV in FIG. 2;

FIG. 5 is a diagram illustrating a coaxial-cable-fed broadband monopole antenna according to one embodiment of the present invention;

FIG. 6 is a diagram illustrating a coaxial-cable-fed broadband dipole antenna according to another embodiment of the present invention; and

FIG. 7 is a diagram illustrating an electric power unit that is connected to the ferrite member; and

FIGS. 8A and 8B are diagrams illustrating application examples of a broadband antenna according to one embodiment of the present invention is applied.

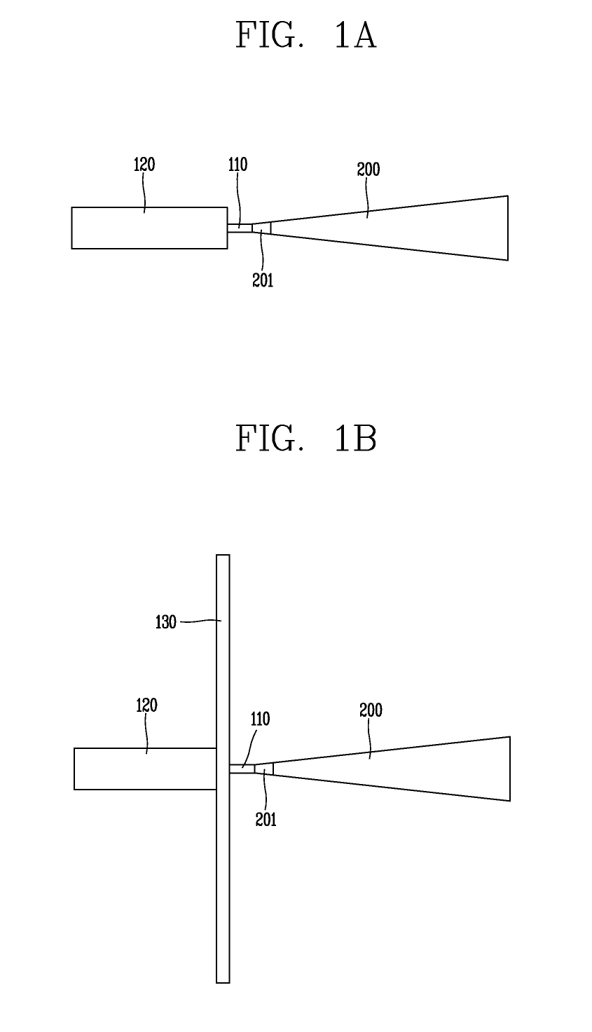

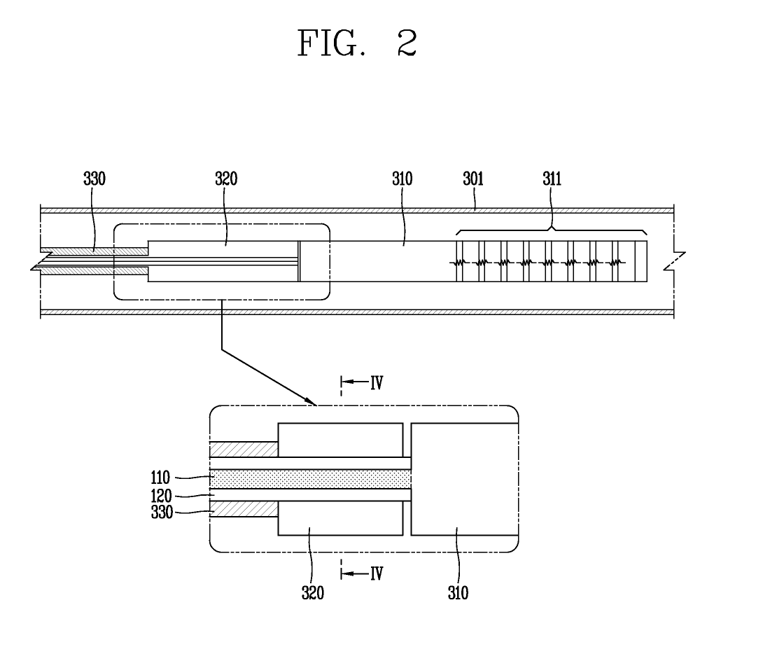

### DETAILED DESCRIPTION

Description will now be given in detail of the exemplary embodiments, with reference to the accompanying drawings. For the sake of brief description with reference to the drawings, the same or equivalent components will be provided with the same reference numbers, and description thereof will not be repeated.

Though terms of ‘first’, ‘second’, etc. are used to explain various components, the components are not limited to the terms. The terms are used only to distinguish one component from another component. For example, a first component may be referred to as a second component, or similarly, the second component may be referred to as the first component within the scope of the present invention.

FIG. 2 is a diagram illustrating a coaxial-cable-fed broadband dipole antenna according to one embodiment of the present invention.

Referring to FIG. 2, the broadband antenna according to the present invention includes a first arm 310 that is connected to one end of a coaxial cable, a second arm 320 and a ferrite member 330 that are formed in such a manner as to surround the coaxial cable, and the like.

The first arm 310 is connected to an inner conductor 110 of the coaxial cable. The first arm 310 is connected to one end of the inner conductor 110 of the coaxial cable, and extends in a lengthwise direction of the coaxial cable.

A resistance load 311 is connected to one end of the first arm 310. According to one embodiment of the present invention, the resistance load 311 is configured as a surface-mounted resistance element and thus its conductance is easy to identify. The resistance load 311 is obtained by connecting multiple resistance elements in series, and is configured in such a manner that the farther the resistance load 311 is positioned away from the first arm 310, the less current is distributed. According to one embodiment of the present invention, it is possible to realize characteristic of the broadband antenna by adding the resistance load 311 to the one end of the first arm 310 as described above.

The second arm 320 is formed in such a manner as to surround the coaxial cable 320, and is connected electrically to an outer conductor of the coaxial cable in such a manner as to make up the antenna.

According to the present invention, a dipole antenna in the shape of a thin pipe is realized by combining the first arm 310 and the second arm 320.

The ferrite member 330 is formed in a manner that is adjacent to the second arm 320 and surrounds the coaxial cable. The ferrite member 330 is formed in the cylindrical shape that surrounds the coaxial cable. According to one embodiment of the present invention, the ferrite member 330 may be formed in such a manner as to come into contact with one end of the second arm 320 and may be arranged in a manner that is placed a given distance away from the one end of the second arm 320. That is, a distance between the ferrite member 330 and the second arm 320 is adjusted in such a manner as to adjust a beam direction and a radiation pattern from the antenna.

The ferrite member 330 suppresses a guide wave that occurs along a thin pipe 301, and removes influence of the cable, and thus the radiation pattern is formed according to an ideal length of the dipole antenna in the broadband.

According to the present invention, a button (not illustrated) that connects to the ferrite member 330 is formed on an external surface of the thin pipe 301. The button connects to the ferrite member 330 with a connection member made of non-conductive material. The button is formed in a manner that is slidably moved in a lengthwise direction along the thin pipe 301 that surrounds the antenna. When the button is moved, the ferrite member 330 also is moved along a surface of the coaxial cable, and thus the distance is adjusted between the ferrite member 330 and the second arm 320. That is, with the button, a user can adjust the radiation pattern from the antenna.

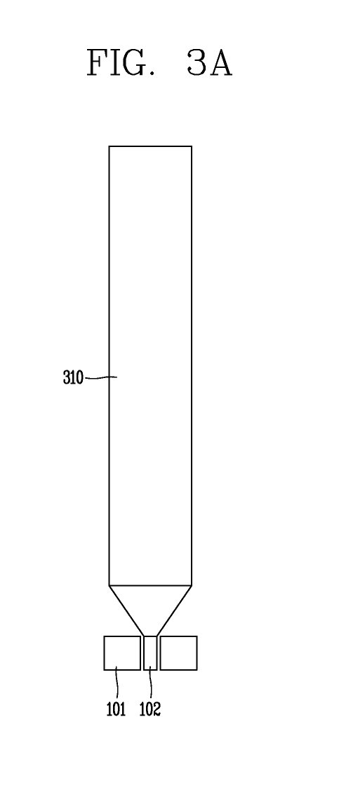

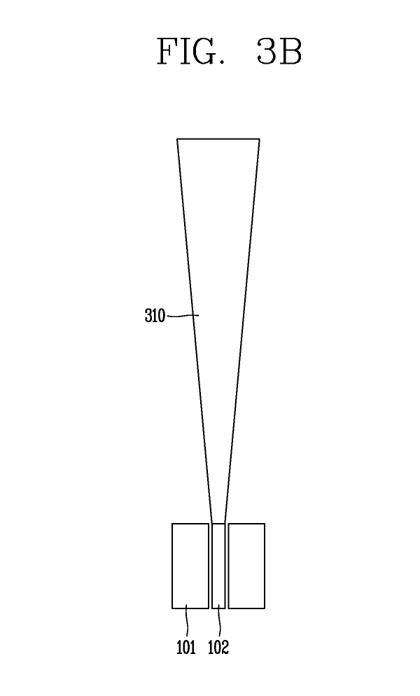

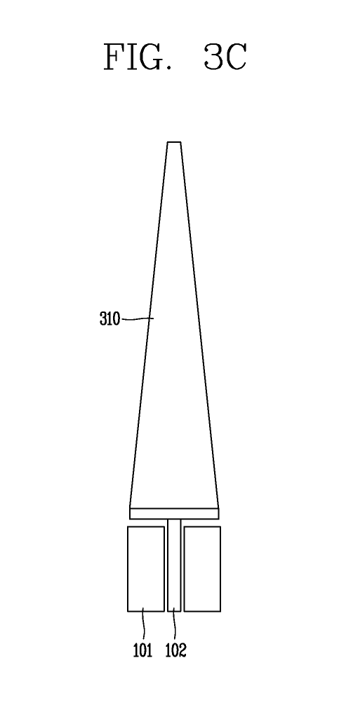

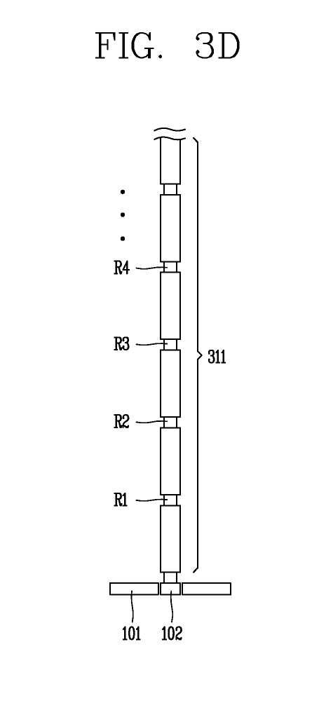

FIGS. 3A to 3D are modification examples of the first arm 310 illustrated in FIG. 2.

Referring to FIGS. 3A to 3D, the first arm 310 may be changed in shape whenever necessary. For example, the first arm 310 may be (a) configured from a combination of a first section of which a radius becomes greater as an opposite end of the first section goes farther away from the inner conductor 110 and a second section of which a length extends with the same radius, may be (2) shape-configured in such a manner that the farther an opposite end of first arm 310 goes away from the inner conductor 110, the greater the radius of the first arm 310, or may be (3) shape-configured in such a manner that the farther the opposite end of the first arm 310 goes away from the inner conductor 110, the smaller the radius of the first arm 310. In addition, like in the resistance load 311 illustrated in FIG. 2, multiple resistors R1, R2, R3, R4, and so forth may be connected in series to one another, and thus it may be possible to realize the antenna in which the further the resistor is positioned away from the inner conductor 110, the less current is distributed.

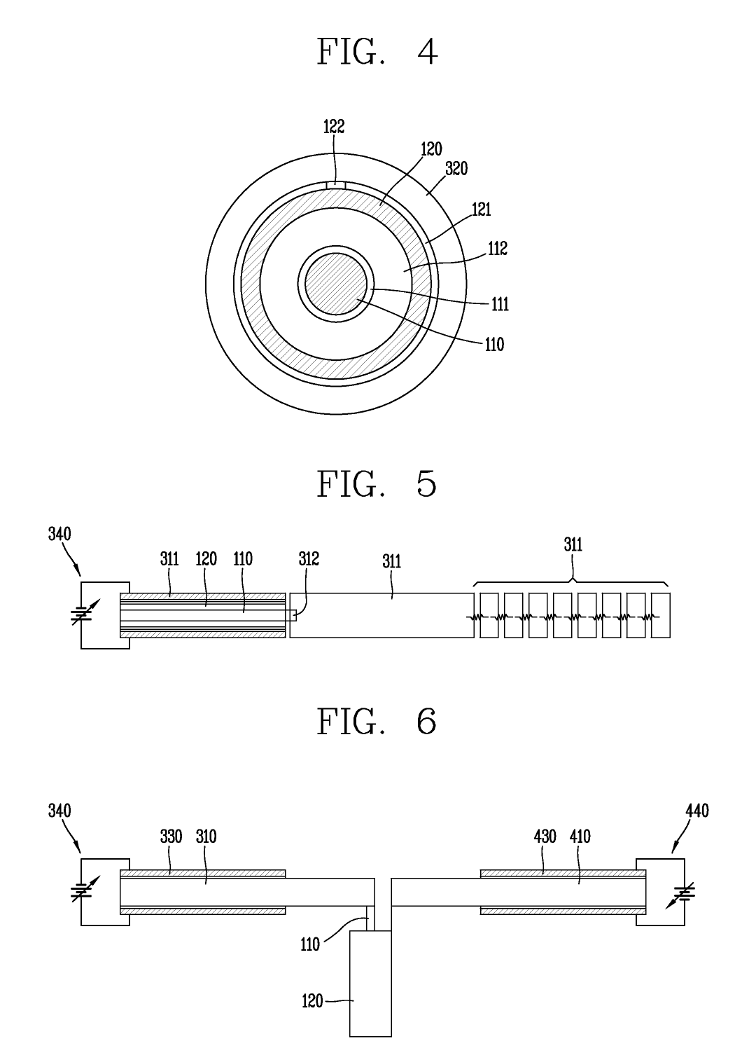

FIG. 4 is a cross-sectional diagram illustrating the antenna according to one embodiment of the present invention, taken along a line IV-IV in FIG. 2.

Referring to FIG. 4, the coaxial cable according to one embodiment of the present invention includes the inner conductor 110, an inner dielectric insulator 111 that insulates the inner conductor 110, the outer conductor 120 that surrounds the inner dielectric insulator 111, an outer dielectric insulator 121 that shields the outer conductor 120, and the like.

The first arm 310 is connected to the inner conductor 110 and extends in the lengthwise direction of the coaxial cable. Since FIG. 4 is the cross-sectional diagram illustrating the antenna taken along the line IV-IV in FIG. 2, the first arm 310 is not illustrated in FIG. 4.

The second arm 320 is configured to be in the cylindrical shape that surrounds the coaxial cable. The outer dielectric insulator is arranged between the second arm 320 and the outer conductor 120. At this point, the second arm 320 and the outer conductor 120 are connected electrically to each other with a conductive connection member 122.

FIG. 5 is a diagram illustrating a coaxial-cable-fed broadband dipole antenna according to one embodiment of the present invention.

In the antenna according to the present embodiment, an electric power unit 340 is connected to the ferrite member, and thus magnetic characteristics of the ferrite member 330 is changed. By changing the magnetic characteristics of the ferrite member 330, a current distributed in the outer conductor 120 of the coaxial cable is controlled.

For example, with the ferrite member 330, current may not be distributed in the outer conductor 120, in which case the radiation pattern is biased toward the arm of the antenna. If with the ferrite member 330, the distribution of current in the outer conductor of the coaxial cable is made to be similar to the distribution of current in the arm of the antenna, a radiation pattern that is similar to that formed in the dipole antenna is formed in a broadband monopole antenna. That is, realization of the dipole antenna is possible with a construction of the monopole antenna.

Referring to FIG. 5, the monopole antenna includes the arm 310 of the antenna that is connected to the inner conductor 110 of the coaxial cable, the ferrite member 330 is arranged in such a manner as to surround the coaxial cable, the electric power unit 340 that is connected to the ferrite member 330, and the like.

A balun 312, which is connected directly to the coaxial cable, is formed between the arm 310 of the antenna and the inner conductor 110. According to the present embodiment, because a radio frequency current is fed directly to the arm 310 of the antenna using the coaxial cable, there is no need for connection to a separate transformer or matching network. If the coaxial cable is connected directly to the balun 312 of the antenna, a reflected wave may be present along an outside of the coaxial cable. However, according to the present embodiment, the reflected wave is removed using the ferrite member 330.

The resistance load 311 is connected to one end of the arm 310 of the antenna. The resistance load 311 is configured as a surface-mounted resistance element and thus its conductance is easy to identify. The resistance load 311 is obtained by connecting multiple resistance elements in series, and is configured in such a manner that the farther the resistance load 311 is positioned away from the arm 310 of the antenna, the less current is distributed. It is possible to realize characteristic of the broadband antenna by adding the resistance load 311 to the one end of the arm 310 of the antenna as described above.

The electric power unit 340 supplies electric power to the ferrite member 330 and thus changes the magnetic characteristics of the ferrite member 330. The electric power unit 340 at this point is configured to operate in such a manner that electric power supplied to feed the radio frequency current to the antenna and electric power supplied through the coaxial cable are separated from each other.

The electric power unit 340 includes a variable power source that is connected electrically to the ferrite member 330. The magnetic characteristics of the ferrite member 330 are changed using the variable power source whenever necessary. The electric power unit 340 is configured to change corresponding to characteristics of the radio frequency current that is fed to the arm 310 of the antenna. This is done by controlling operation of the electric power unit 340 through a control circuit. That is, if the characteristics of the radio frequency current that is fed to the antenna is changed and thus the radiation pattern from the arm 310 of the antenna is changed, the electric power unit 340 controls the distribution of current in the outer conductor of the coaxial cable by changing the magnetic properties of the ferrite member 330, in order to correspond to such a change.

FIG. 6 is a diagram illustrating a coaxial-cable-fed broadband dipole antenna according to another embodiment of the present invention.

Referring to FIG. 6, the dipole antenna includes the first arm 310 that is connected to the inner conductor 110, and a second arm 410 that is connected to the outer conductor 120 of the coaxial cable. Ferrite members are present around the first arm 310 and the second arm 410, respectively. The first and second arms 310 and 410 include the balun that is connected directly to the coaxial cable, not through the matching network. The reflected wave that occurs at this time is controlled by the ferrite members that are connected to the first and second arms.

For description convenience, the ferrite member that is connected to the first arm 310 is referred to as a first ferrite member 330 and the ferrite member that is connected to the second arm 410 is referred to as a second ferrite member 430.

The first arm 310 is connected to the inner conductor 110 of the coaxial cable, and the balun is formed between the inner conductor 110 and the first arm 310. The first ferrite member 330 is formed around the first arm 310. The first ferrite member 330 is connected to the first arm 310 in such a manner as to surround the first arm 310, and thus controls current that occurs along a surface of the first arm 310. According to one embodiment of the present invention, a first electric power unit 340 is connected to the first ferrite member 330. The first electric power unit 340 changes magnetic properties of the first ferrite member 330, and thus adjusts distribution of current that occurs in the first arm 310. According to electric power that is applied through the first electric power unit 340, electrical characteristics of the ferrite member 330 are changed, and thus an electrically-effective length of the antenna is changed.

The second arm 410 is connected to the outer conductor 120 of the coaxial cable. Like the first arm 310, the second arm 410 may include a balun to which the radio frequency is fed from the outer conductor 120 of the coaxial cable. The second ferrite member 430 is connected to the second arm 410 in such a manner as to surround the second arm 410, and thus control current that occurs along a surface of the second arm 410. According to one embodiment of the present invention, a second electric power unit 440 is connected to the second ferrite member 430. The second electric power unit 440 changes magnetic properties of the second ferrite member 430, and thus adjusts distribution of current that occurs in the second arm 410. According to electric power that is applied through the second electric power unit 440, electrical characteristics of the ferrite member 430 are changed, and thus an electrically-effective length of the antenna is changed.

The first electric power unit 340 is separated in a lengthwise direction of the first arm 310 and thus includes multiple power sources that are connected to the first ferrite member 330. The multiple power sources are individually controlled in such a manner as to control distribution of current that occurs on the surface of the first arm 310. For example, the closer the power source is to the balun, the more current is distributed, and this creates a similar effect to one in which the resistance load 311 is connected to one end of the arm 310.

Likewise, the second electric power unit 440 is separated in a lengthwise direction of the second arm 410 and thus includes multiple power sources that are connected to the second ferrite member 430. The multiple power sources are individually controlled in such a manner as to control distribution of current that occurs on the surface of the second arm 410. For example, the closer the power source is to the balun, the more current is distributed, and this creates a similar effect to one in which the resistance load 311 is connected to one end of the arm 310.

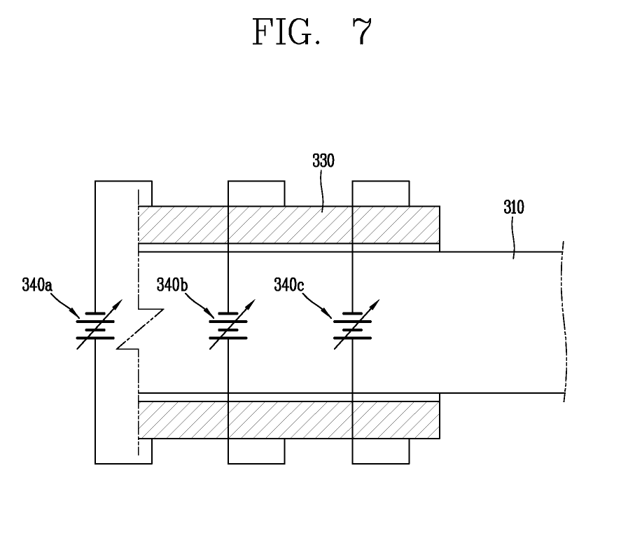

FIG. 7 is a diagram illustrating the electric power unit that is connected to the ferrite member.

A configuration of the electric power unit that includes the multiple power sources illustrated in FIG. 7 is applied to all the ferrite members described referring to FIGS. 2, 5 and 6.

Referring to FIG. 7, the ferrite member 330 is arranged outside of the arm 310 of the antenna, and thus control distribution of current that occurs in the arm 310 of the antenna is controlled. The electric power unit 340 is connected to the ferrite member 330, and includes multiple power sources 340a, 340b, and 340c that are arranged in a manner that is separated from one another in a lengthwise direction of the arm 310 of the antenna. In FIG. 7, according to one embodiment, only the three power sources are illustrated, but the number of the power sources varies whenever necessary. The power sources may have different voltages. For example, the first, second, and third power source 340a, 340b, and 340c have the highest voltage, the second highest voltage, and the third highest voltage, respectively.

According to another embodiment of the present invention, the ferrite member 330 may be separately divided in the lengthwise direction of the arm 310 of the antenna. That is, the ferrite member 330 is a first part that is connected to the first power source 340a, a second part that is connected to the second power source 340b, a third part that is connected to the third power source 340c, and so forth. An insulation member, or a ferrite member that is different in a chemical composition rate from the ferrite member 330 may be arranged among the first to third parts.

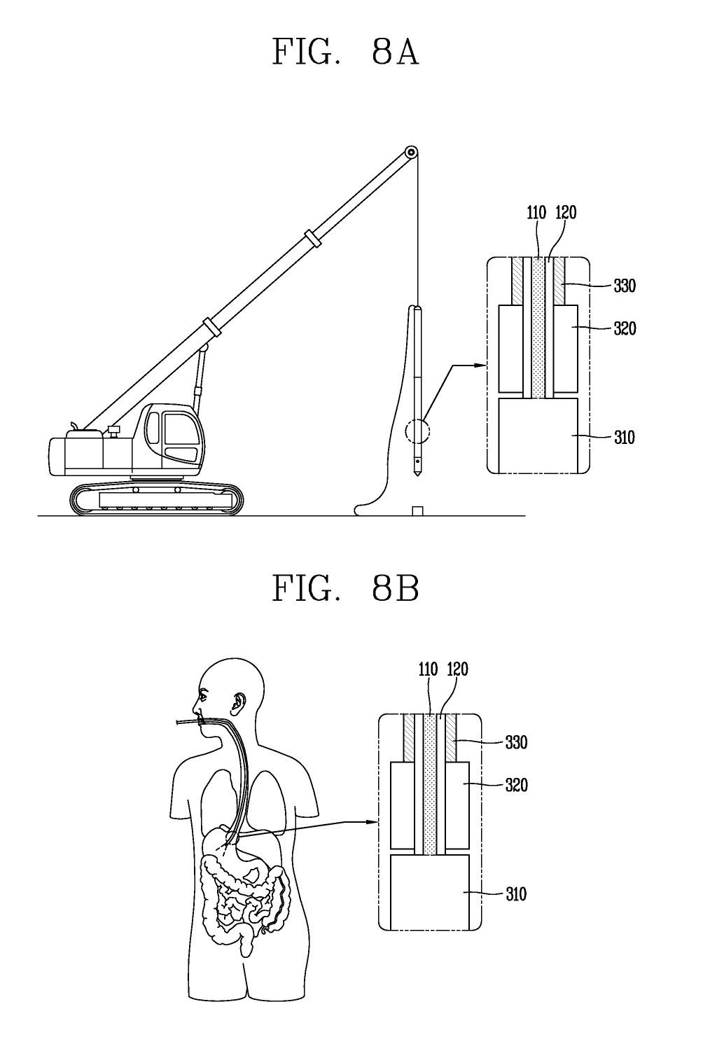

FIG. 8A is an application example in which the present invention is applied to an antenna for a bore hole. The antenna for the bore hole is shape-configured in such a manner that its width is smaller compared to its length.

Embodiments described above may be applied to the antenna for the bore hole illustrated in FIG. 8A.

For example, the coaxial cable is arranged within the antenna for the bore hole. The antenna for the bore hole includes the first arm 310 that is connected to one end of the coaxial cable, the second arm 320 and the ferrite member that are formed in such a manner as to surround the coaxial cable, and the like.

The first arm 310 is connected to the inner conductor 110 of the coaxial cable. The first arm 310 is connected to one end of the inner conductor 110 of the coaxial cable, and extends in the lengthwise direction of the coaxial cable.

The resistance load 311 is connected to one end of the first arm 310. According to one embodiment of the present invention, the resistance load is configured as a surface-mounted resistance element and thus its conductance is easy to identify. The resistance load 311 is obtained by connecting multiple resistance elements in series, and is configured in such a manner that the farther the resistance load 311 is positioned away from the first arm 310, the less current is distributed. According to one embodiment of the present invention, it is possible to realize characteristic of the broadband antenna by adding the resistance load to the one end of the first arm 310 as described above.

The second arm 320 is formed in such a manner as to surround the coaxial cable 320, and is connected electrically to an outer conductor of the coaxial cable in such a manner as to make up the antenna.

The ferrite member 330 is formed in a manner that is adjacent to the second arm 320 and surrounds the coaxial cable. The ferrite member 330 is formed in the cylindrical shape that surrounds the coaxial cable. According to one embodiment of the present invention, the ferrite member 330 may be formed in such a manner as to come into contact with one end of the second arm 320. According to another embodiment of the present invention, the ferrite member 330 may be arranged in a manner that is placed a given distance away from the one end of the second arm 320. That is, a distance between the ferrite member 330 and the second arm 320 is adjusted in such a manner as to adjust a beam direction and a radiation pattern from the antenna.

The ferrite member 330 suppresses the guide wave that occurs along a thin pipe 301, and removes influence of the cable, and thus the radiation pattern is formed according to an ideal length of the dipole antenna in the broadband.

FIG. 8B illustrates an application example in which the present invention is applied to an endoscope.

The endoscope includes a main body, a cylindrical pipe that is inserted into a human body, and the like.

The cylindrical pipe is formed in a manner that is bent in a desired direction. An imaging module is mounted on one end of the cylindrical pipe and captures an object. In addition, an antenna module is mounted into the cylindrical pipe and diagnoses a region of which an image cannot be captured by the imaging module. That is, with the endoscope according to the present embodiment, an image of a surface of the object that is captured using an endoscope camera and an image that is captured using an electromagnetic wave are obtained at the same time.

The imaging module includes an imaging element that includes a CCD for observation with normal light or a CCD for observation with fluorescent light, a light source that emits light to an object, a circuit unit that electrically connects the imaging element and the light source, and the like.

The antennas described referring to FIGS. 2 to 7 are applied to the antenna module.

The antenna module includes the broadband antenna and the balun. The antenna module is arranged within the cylindrical pipe, and thus a compact design of the endoscope is possible. In other words, with a construction according to the present invention, it is possible that the endoscope is equipped with new functions without needing to increase a size of the endoscope.

Since using the coaxial cable, the radio frequency current is fed directly to the broadband antenna with the configuration described above according to at least one embodiment of the present invention, a separate matching element is unnecessary. Therefore, the construction of the antenna is not only made to be simple, but performance of the antenna can be also improved.

In addition, according to the present invention, the use of the coaxial cable makes the broadband antenna simple in construction. Thus, when the broadband antenna is applied to an apparatus that, like an endoscope, is small in width and needs a broad frequency band, performance of the apparatus can be improved.

In addition, in the antenna according to the present invention, a current that is distributed along the coaxial cable can be controlled using the ferrite member, and thus the radiation pattern can be prevented from being distorted due to the coaxial cable.

Furthermore, according to the present invention, an ideal radiation pattern can be formed by connecting the power source to the ferrite member that surrounds the coaxial cable, and an effect that is possible with the dipole antenna can be accomplished with the construction of the monopole antenna.

The foregoing embodiments and advantages are merely exemplary and are not to be considered as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds are therefore intended to be embraced by the appended claims.

What is claimed is:

1. A broadband antenna comprising:
a coaxial cable;
a first arm that is connected to an inner conductor of the coaxial cable and extends in a lengthwise direction of the coaxial cable;
a second arm that is connected to an output conductor of the coaxial cable, and surrounds the coaxial cable; and
a ferrite member that is formed adjacent to the second arm and surrounds the coaxial cable to control current that is distributed along the outer conductor of the coaxial cable.

2. The broadband antenna of claim 1, further comprising a resistance load that is connected to one end of the first arm so as to extend in the lengthwise direction.

3. The broadband antenna of claim 2, further comprising an electric power unit that is connected to the ferrite member.

4. The broadband antenna of claim 3, wherein the electric power unit includes a variable power source.

5. The broadband antenna of claim 3, wherein the electric power unit includes the multiple power sources that are separated from one another in a lengthwise direction of the coaxial cable.

6. The broadband antenna of claim 5, wherein the electric power unit provides the ferrite member with distribution of current that is matched to distribution of current with which the resistance load is provided.

7. A broadband antenna comprising:
a coaxial cable;
an antenna arm that is connected to an inner conductor of the coaxial cable and extends in a lengthwise direction of the coaxial cable;
a power feeding portion that connects the coaxial cable and the antenna arm of the broadband antenna;
a resistance load that is connected to on one end of the antenna arm of the broadband antenna so as to extend in a lengthwise direction of the coaxial cable; and
a ferrite member that surrounds the coaxial cable to control current that is distributed along an outer conductor of the coaxial cable.

8. The broadband antenna of claim 7, further comprising an electric power unit that is connected to the ferrite member.

9. The broadband antenna of claim 8, wherein the electric power unit includes the multiple power sources that are separated from one another in a lengthwise direction of the coaxial cable.

10. The broadband antenna of claim 9, wherein the electric power unit provides the ferrite member with distribution of current that is matched to distribution of current with which the arm of the broadband antenna.

11. A broadband dipole antenna comprising:
a coaxial cable;
a first arm that is connected to an inner conductor of the coaxial cable;
a second arm that is connected to an outer conductor of the coaxial cable and extends;
a first ferrite member that is formed in such a manner as to surround the first arm; and
a second ferrite member that is formed in such a manner as to surround the second arm.

12. The broadband dipole antenna of claim 11, further comprising electric power units that are connected to the first and second ferrite members in such a manner as to adjust distribution of current with which the first and second arms are formed, respectively.

13. The broadband dipole antenna of claim 12, wherein the electric power units provide the first arm and the second arm with matched distribution of current, respectively.

14. The broadband dipole antenna of claim 13, wherein each of the electric power units includes multiple power sources that are separated from one another.

15. The broadband dipole antenna of claim 13, wherein each of the electric power units includes a variable power source that changes corresponding to a radio frequency current that is fed to the first and second arms.
